(19) United States
(12) Patent Application Publication
(10) Pub. No.: US 2025/0142261 A1
(43) Pub. Date: May 1, 2025

(54) SPEAKER DEVICE

(71) Applicant: MERRY ELECTRONICS (SUZHOU) CO., LTD., Jiangsu Province (CN)

(72) Inventors: LiGuo Rao, Jiangsu Province (CN); ChunLong ZHENG, Jiangsu Province (CN)

(73) Assignee: MERRY ELECTRONICS (SUZHOU) CO., LTD., Jiangsu Province (CN)

(21) Appl. No.: 18/909,257

(22) Filed: Oct. 8, 2024

(30) Foreign Application Priority Data
Oct. 30, 2023 (CN) 202311425683.0

(51) Int. Cl. H04R 9/06; H04R 7/04; H04R 7/18; H04R 9/02

(52) U.S. Cl. CPC H04R 9/06; H04R 7/04; H04R 7/18; H04R 9/025; H04R 2400/11

(57) ABSTRACT

This application discloses a speaker device, including: a magnetic guide plate, a magnetic circuit module and a vibration module. The main magnetic and the auxiliary magnetic of the magnetic circuit module are disposed on the magnetic guide plate, the first bearing platform of the auxiliary magnetic guide component is disposed inside of the second bearing platform, the first protrusion platform of the first bearing platform is disposed inside of the second protrusion platform. The bracket of the vibration module is disposed on the auxiliary magnetic and the magnetic guide plate, the vibration component is disposed above the bracket, the vibration component includes a diaphragm and an elastic support component, two sides of the elastic support component respectively connect to the diaphragm and the bracket, the elastic support component is located on the first bearing platform, and the voice coil is disposed under the diaphragm.

### CROSS REFERENCE TO RELATED APPLICATION

This application claims the priority benefit of Chinese Patent Application Serial Number 202311425683.0, filed on Oct. 30, 2023, the full disclosure of which is incorporated herein by reference.

### BACKGROUND

### Technical Field

The present application is related to a technical field of designing a waterproof speaker device, specifically focusing on a speaker device.

### Related Art

In the current market, waterproof speakers used in smartwatches and wearable devices are designed with separate structures for sealing and waterproofing. Due to the independent designs of these structures and the speaker itself, there is a lack of effective and proper integration between them. As a result, the overall waterproof performance of the speaker is compromised. Furthermore, when the waterproof structure of the speaker is submerged in water, the speaker itself needs to have enough structural strength to withstand external water pressure. Therefore, if the waterproof structure of the speaker is not appropriately integrated with the speaker structure and the speaker may endure less pressure, the speaker is susceptible to water seepage. Consequently, this vulnerability to external water pressure can lead to water leakage, resulting in potential damage to the internal components of the speaker.

### SUMMARY

The embodiments in this application provide a speaker device where a first bearing platform is disposed under the elastic support component, allowing the first bearing platform to provide auxiliary support to the elastic support component. This resolves the issue of the speaker device having insufficient supporting strength against external forces.

To resolve the abovementioned technical issue, the present application is embodied as follows.

A speaker device is provided, including: a magnetic guide plate, a magnetic circuit module and a vibration module. The magnetic circuit module includes a main magnetic, an auxiliary magnetic, a main magnetic guide component and an auxiliary magnetic guide component. The main magnetic guide component is disposed on the main magnetic, the auxiliary magnetic guide component is disposed on the auxiliary magnetic, the auxiliary magnetic guide component further includes a first bearing platform and a second bearing platform, the first bearing platform is disposed inside of the second bearing platform, the first bearing platform further includes a first protrusion platform and a second protrusion platform, the first protrusion platform is located inside of the second protrusion platform, and a height from a top surface of the second protrusion platform to a top surface of the auxiliary magnet is higher than a height from a top surface of the first protrusion platform to the top surface of the auxiliary magnet. The vibration module includes a bracket, a vibration component and a voice coil. The bracket is disposed on the auxiliary magnetic and the magnetic guide plate, and vibration component is disposed above the bracket, the vibration component includes a diaphragm and an elastic support component, an inner side of the elastic support component supports a periphery of the diaphragm, an outer side of the elastic support component is disposed on the bracket, the clastic support component is integrally injection-molded between the diaphragm and the bracket, the elastic support component is located on the first bearing platform, the voice coil is disposed under the diaphragm, and the voice coil is located between the main magnetic and the auxiliary magnetic.

In one embodiment, a height from a top surface of the first bearing platform to the top surface of the auxiliary magnet is higher than a height from a top surface of the second bearing platform to the top surface of the auxiliary magnetic.

In one embodiment, a top surface of the first protrusion platform is inclined in connection to a top surface of the second protrusion platform.

In one embodiment, the bracket includes a frame body and a connection pillar, the frame body is disposed on the auxiliary magnetic, one end of the connection pillar extends downward from the frame body to the magnetic guide plate to be fixed thereon.

In one embodiment, the frame body adjacent to the auxiliary magnetic guide component has a bottom with a notch, the first bearing platform of the auxiliary magnetic guide component embeds in the notch.

In one embodiment, the auxiliary magnetic guide component has an outer side with a side notch, and the connection pillar has one end passing through the side notch.

In one embodiment, the auxiliary magnetic has two sides, each with its respective notch, and the connection pillar has one end passing through the notch.

In one embodiment, the magnetic guide plate has an outer side with a plate notch and has a bottom surface, the connection pillar has one end passing through the plate notch, and the one end of the connection pillar is fixed on the bottom surface of the magnetic guide plate.

In one embodiment, the frame body of the bracket includes a top wall, an inner sidewall and an outer sidewall, two sides of the top wall connect to the inner sidewall and the outer sidewall respectively, the elastic support component includes a connection part, an elastic part with an inner side and an outer side, and a fixing part with an inner side, the connection part has an inner side surrounding a periphery of the diaphragm, the connection part has an outer side connecting to an inner side of the elastic part, an outer side of the elastic part is connected to an inner side of the fixing part, and the fixing part is formed on the inner sidewall, the top wall and the outer sidewall.

In one embodiment, a vertical height from the top surface of the second protrusion platform to the top surface of the first protrusion platform is greater than or equal to half of a vertical height from a bottom end of the elastic part to a bottom of the diaphragm.

In one embodiment, one side of the fixing part corresponding to the outer sidewall includes a protrusion part.

In one embodiment, the protrusion part includes a convex surface, a first side surface and a second side surface, the first side surface and the second side surface are located two sides of the convex surface respectively, and the first side surface and the second side surface are symmetrically disposed relative to the convex surface.

In one embodiment, the outer sidewall includes a first recess, and the fixing part covers the first recess.

In one embodiment, the outer sidewall further includes a second recess, the second recess is located in the first recess, and the second recess is adjacent to the top wall.

In one embodiment, the first recess and the second recess are disposed in a stepped configuration.

In one embodiment, the inner sidewall includes a third recess with a recess bottom, a recess wall and a sidewall, the outer side of the elastic part includes a first elastic connection part and a second clastic connection part, the first elastic connection part extends and attaches toward the recess bottom and recess wall of the third recess, the second elastic connection part extends and attaches toward above of the sidewall of the third recess, and the second elastic connection part is connected to the fixing part.

In one embodiment, the inner side of the connection part surrounds the periphery of the diaphragm.

In one embodiment, the inner side of the connection part surrounds a top surface of the diaphragm, a thickness of the connection part at a center of the diaphragm is thinner than a thickness of the connection part at the periphery of the diaphragm.

In one embodiment, the connection part extends and surrounds a bottom periphery of the diaphragm.

The present application provides a speaker device. By the first protrusion platform and the second platform of the first bearing platform positioned under the clastic support component, and the distance from the first bearing platform to the clastic support component less than half the amplitude of the vibration component of the speaker device, when the elastic support component undergoes inward folding deformation due to external pressure, the first protrusion platform and the second protrusion platform of the first bearing platform support the bottom of the clastic support component. In this way, the first bearing platform enhances the outward supporting strength of the clastic support component.

It should be understood, however, that this summary may not contain all aspects and embodiments of the present invention, that this summary is not meant to be limiting or restrictive in any manner, and that the invention as disclosed herein will be understood by one of ordinary skill in the art to encompass obvious improvements and modifications thereto.

### BRIEF DESCRIPTION OF THE DRAWINGS

The accompanying drawings herein are provided to have a further understanding on the present application and constitutes a part of the present application. The schematic embodiments and the description of the present application is used to explain the present application instead of constituting inappropriate limitation. In the drawings:

FIG. 1 is a three-dimensional diagram of the speaker device in this application.

FIG. 2 is another three-dimensional diagram of the speaker device in this application.

FIG. 3 is an exploded view of the speaker device in this application.

FIG. 4 is another exploded view of the speaker device in this application.

FIG. 5 is a sectional view along line A-A′ of FIG. 1.

FIG. 6 is an enlarged view of region B in FIG. 5.

FIG. 7 is an enlarged operation diagram of region B in FIG. 5.

The illustration is provided in conjunction with the accompanying drawings: 1: speaker device; 11: magnetic guide plate; 111: plate notch; 13: magnetic circuit module; 131: main magnetic; 132: auxiliary magnetic; 1320: notch; 133: main magnetic guide component; 134: auxiliary magnetic guide component; 1340: side notch; 1341: first bearing platform; 13411: first protrusion platform; 13412: second protrusion platform; 1342: second bearing platform; 1343: circuit notch; 15: vibration module; 151: bracket; 1511: frame body; 15110: notch; 15111: top wall; 15112: inner sidewall; 15113: outer sidewall; 15114: first recess; 15115: second recess; 15116: third recess; 1512: connection pillar; 152: vibration component; 1521: diaphragm; 1522: elastic support component; 15221: connection part; 15222: elastic part; 15223: fixing part; 15224: protrusion part; 15225: convex surface; 15226: first side surface; 15227: second side surface; 15228: first clastic connection part; 15229: second elastic connection part; 153: voice coil; 17: conductive component; 171: conductive part; 172: conductive circuit; H1, H2: vertical height.

### DETAILED DESCRIPTION OF THE EMBODIMENTS

The present invention will now be described more fully hereinafter with reference to the accompanying drawings, in which exemplary embodiments of the invention are shown. This present invention may, however, be embodied in many different forms and should not be construed as limited to the embodiments set forth herein. Rather, these embodiments are provided so that this present invention will be thorough and complete, and will fully convey the scope of the present invention to those skilled in the art.

Certain terms are used throughout the description and following claims to refer to particular components. As one skilled in the art will appreciate, manufacturers may refer to a component by different names. This document does not intend to distinguish between components that differ in name but function. In the following description and in the claims, the terms “include/including” and “comprise/comprising” are used in an open-ended fashion, and thus should be interpreted as “including but not limited to”. “Substantial/substantially” means, within an acceptable error range, the person skilled in the art may solve the technical problem in a certain error range to achieve the basic technical effect.

The following description is of the best-contemplated mode of carrying out the invention. This description is made for the purpose of illustration of the general principles of the invention and should not be taken in a limiting sense. The scope of the invention is best determined by reference to the appended claims.

Moreover, the terms “include”, “contain”, and any variation thereof are intended to cover a non-exclusive inclusion. Therefore, a process, method, object, or device that comprises a series of elements not only include these elements, but also comprises other elements not specified expressly, or may include inherent elements of the process, method, object, or device. If no more limitations are made, an element limited by “include a/an . . . ” does not exclude other same elements existing in the process, the method, the article, or the device which comprises the element.

In the following embodiment, the same reference numerals are used to refer to the same or similar elements throughout the invention.

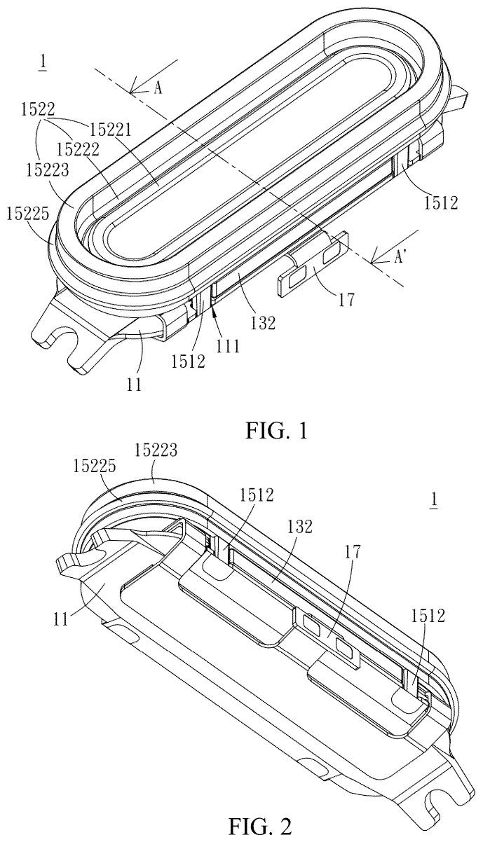

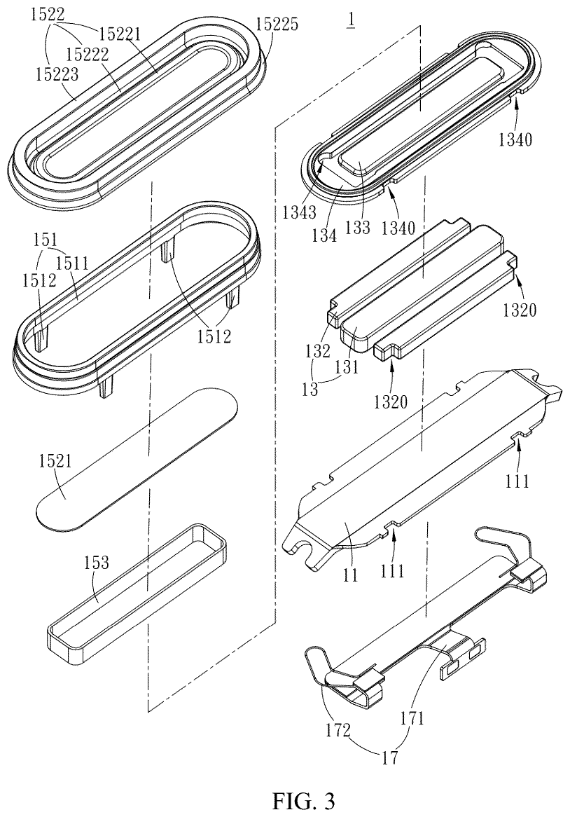

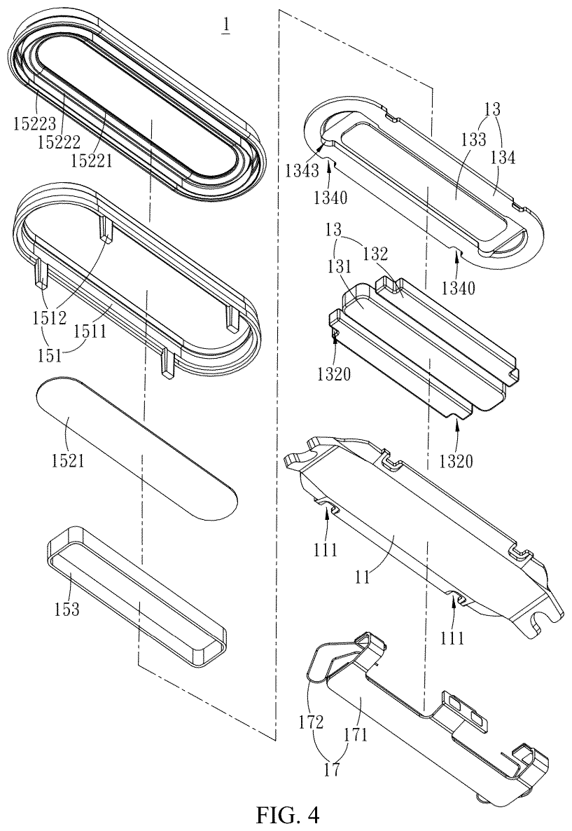

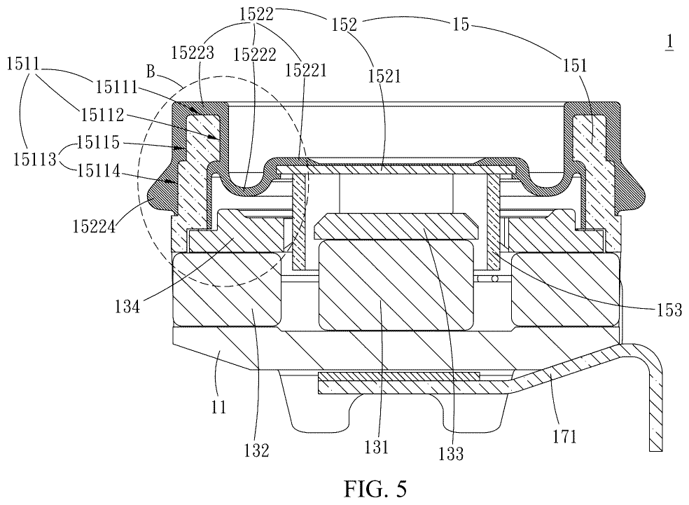

Please refer to FIG. 1 to FIG. 5 where FIG. 1 is a three-dimensional diagram of the speaker device in this application, FIG. 2 is another three-dimensional diagram, FIG. 3 is an exploded view, FIG. 4 is another exploded view and FIG. 5 is a sectional view along line A-A′ of FIG. 1. As shown in the figures, the present application provides a speaker device 1, including: a magnetic guide plate 11, a magnetic circuit 13 and a vibration module 15. The magnetic circuit 13 includes a main magnetic 131, an auxiliary magnetic 132, a main magnetic guide component 133 and an auxiliary magnetic guide component 134. The main magnetic 131 and the auxiliary magnetic 132 are disposed on the magnetic guide plate 11, the auxiliary magnetic 132 is disposed outside of the main magnetic 131, the main magnetic guide component 133 is disposed on the main magnetic 131, the auxiliary magnetic guide component 134 is disposed on the auxiliary magnetic 132, the auxiliary magnetic guide component 134 further includes a first bearing platform 1341 and a second bearing platform 1342, the first bearing platform 1341 is disposed inside of the second bearing platform 1342, the first bearing platform 1341 further includes a first protrusion platform 13411 and a second protrusion platform 13412, the first protrusion platform 13411 is disposed inside of the second protrusion platform 13412, the height from the top surface of the second protrusion platform 13412 to the top surface of the auxiliary magnetic 132 is higher than the height from the top surface of the first protrusion platform 13411 to the top surface of the auxiliary magnetic 132. The vibration module 15 includes a bracket 151, a vibration component 152 and a voice coil 153. The bracket 151 is disposed on the auxiliary magnetic 132 and the magnetic guide plate 11, the vibration component 152 is disposed on the bracket 151, the vibration component 152 includes a diaphragm 1521 and an 1522, the inner side of the elastic support component 1522 supports the periphery of the diaphragm 1521, the outer side of the elastic support component 1522 is disposed on the bracket 151, the elastic support component 1522 is disposed on the first bearing platform 1341, the voice coil 153 is disposed under the diaphragm 1521, and the voice coil 153 is located between the main magnetic 131 and the auxiliary magnetic 132.

In this embodiment, the bracket 151 of the vibration module 15 includes a frame body 1511 and multiple connection pillars 1512, there are four connection pillars 1512, each corresponding to one of the positions adjacent to the four corners of the frame body 1511, the frame body 1511 is disposed on the auxiliary magnetic 132, one end of the connection pillar 1512 extends downward from the frame body 1511 to the magnetic guide plate 11 to be fixed thereon. The frame body 1511 adjacent to the auxiliary magnetic guide component 134 has a bottom with a notch 15110, and the first bearing platform 1341 of the auxiliary magnetic guide component 134 embeds in the notch 15110. Furthermore, the outer side of the auxiliary magnetic guide component 134 has side notches 1340, and one end of the connection pillar 1512 passes through the corresponding side notch 1340, respectively. The auxiliary magnetic 132 has two sides, each with its respective notch 1320, and one end of the connection pillar 1512 passes through the notch 1320. The outer side of the magnetic guide plate 11 has plate notches 111, one end of the connection pillar 1512 passes through the plate notch 111 and is fixed on the bottom surface of the magnetic guide plate 11. The above- mentioned side notches 1340, notches 1320 and plate notches 111 are correspondingly interconnected, and one end of the connection pillar 1512 passes through the side notch 1340, notch 1320 and plate notch 111 sequentially and then is fixed. By fixing one end of the connection pillar 1512 of the bracket 151 of the vibration module 15 on the bottom of the magnetic guide plate 11, this embodiment enhances the overall structure strength of the speaker device 1 and raises the drop protection of the speaker device 1.

In this embodiment, the magnetic circuit 13 includes the main magnetic 131, auxiliary magnetic 132, main magnetic guide component 133 and auxiliary magnetic guide component 134, and the main magnetic guide component 133 and the auxiliary magnetic guide component 134 are used to concentrate the magnetic flux line of the main magnetic 131 and the auxiliary magnetic 132 to enhance the magnetic strength of the main magnetic 131 and the auxiliary magnetic 132. Furthermore, the main magnetic guide component 133 is a long plate structure corresponding to the rectangular structure of the main magnetic 131. The main magnetic guide component 133 serves as a structure to assist in strengthening the magnetic field of the main magnetic 131. The auxiliary magnetic guide component 134 not only can serve as a structure to assist in strengthening the magnetic field of the auxiliary magnetic 132, in addition, the annular structure of the auxiliary magnetic guide component 134 is corresponding to the annular structure of the bracket 151 of the vibration module 15, the auxiliary magnetic guide component 134 but also can serve as the auxiliary support structure of the vibration module 15.

In this embodiment, the frame body 1511 of the bracket 151 of the vibration module 15 includes a top wall 15111, an inner sidewall 15112 and an outer sidewall 15113, two sides of the top wall 15111 respectively connect to the inner sidewall 15112 and the outer sidewall 15113, the elastic support component 1522 includes a connection part 15221, an elastic part 15222 and a fixing part 15223, and the connection part 15221, elastic part 15222 and fixing part 15223 of the elastic support component 1522 are integrally formed. The inner side of the connection part 15221 surrounds the periphery of the diaphragm 1521, the outer side of the connection part 15221 connects to the inner side of the elastic part 15222, the outer side of the elastic part 15222 connects to the inner side of the fixing part 15223, and the fixing part 15223 is injection-molded onto the inner sidewall 15112, top wall 15111 and outer sidewall 15113. In this embodiment, the elastic support component 1522 not only serves as the waterproof outer layer of the speaker device 1, but also serves as the vibration sound-producing structure for the speaker device 1. The elastic support component 1522 of the vibration component 152 is manufactured by injection-molding onto the frame body 1511 of the bracket 151.

As the abovementioned, the fixing part 15223 serves as the structure to secure the elastic support component 1522 onto the frame body 1511. The fixing part 15223 is molded onto the inner sidewall 15112, top wall 15111 and outer sidewall 15113 in which the outer sidewall 15113 includes a first recess 15114, and the fixing part 15223 covers the first recess 15114. The outer sidewall 15113 further includes a second recess 15115, the second recess 15115 is located in the first recess 15114, and the second recess 15115 is adjacent to the top wall 15111. The first recess 15114 and the second recess 15115 are disposed in a stepped configuration. When the fixing part 15223 surrounds the outer sidewall 15113 and first recess 15114 of the frame body 1511, in addition to the increased contact area with the outer sidewall 15113, the structure of fixing part 15223 being secured to the non-planar outer sidewall 15113 can also provide stress in non-uniform directions. This facilitates the placement of fixing part 15223 on the outer sidewall 15113 of the frame body 1511. Furthermore, the fixing part 15223 simultaneously surrounds the top wall 15111 and the inner sidewall 15112 fixed on the different plane of the frame body 1511, and the fixing part 15223 has a good fixing effect and strength for the frame body 1511.

Additionally, one side of the fixing part 15223 corresponding to the outer sidewall 15113 includes a protrusion part 15224, wherein the protrusion part 15224 includes a convex surface 15225, a first side surface 15226 and a second side surface 15227, the first side surface 15226 and the second side surface 15227 are located on two sides of the convex surface 15225, and the first side surface 15226 and the second side surface 15227 are symmetrically disposed relative to the convex surface 15225 so that the convex surface 15225, first side surface 15226 and second side surface 15227 can disperse the compressive pressure applied from the outside to the inside of the speaker device 1. This disperses the external pressure onto the first side surface 15226 and the second side surface 15227 relative to the convex surface 15225, thereby relieving the internal pressure on the speaker device 1.

In this embodiment, the inner sidewall 15112 includes a third recess 15116, the elastic part 15222 of the elastic support component 1522 has the largest tensile toughness, the outer side of the elastic part 15222 of the elastic support component 1522 includes a first elastic connection part 15228 and a second elastic connection part 15229, the first elastic connection part 15228 extends and attaches toward the recess bottom and recess wall of the third recess 15116, the second elastic connection part 15229 extends and attaches toward above of the sidewall of the third recess 15116, and the second elastic connection part 15229 is connected to the fixing part 15223. When the first clastic connection part 15228 and second elastic connection part 15229 of the elastic part 15222 are fixed on the inner sidewall 15112, the first elastic connection part 15228 and the second elastic connection part 15229 can provide fixed stresses from two directions, making the elastic part 15222 fix stably on the inner sidewall 15112.

Furthermore, the inner side of the connection part 15221 of the elastic support component 1522 surrounds the periphery of the diaphragm 1521, the connection part 15221 extends and attaches the top surface of the diaphragm 1521, the thickness of the connection part 15221 located at a center of the diaphragm 1521 is thinner than the thickness of the connection part 15221 located at the periphery of the diaphragm 1521, therefore, the sound can be emitted from the diaphragm 1521 smoothly, and the structure strength of the elastic support component 1522 and diaphragm 1521 can be enhanced. Still more, the connection part 15221 extends and attaches the bottom periphery of the diaphragm 1521 so that the fixing strength between the elastic support component 1522 and the diaphragm 1521 is strong.

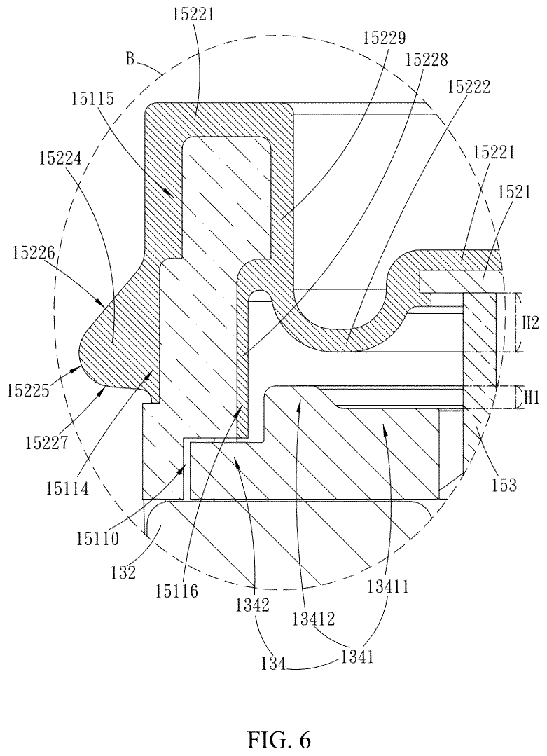

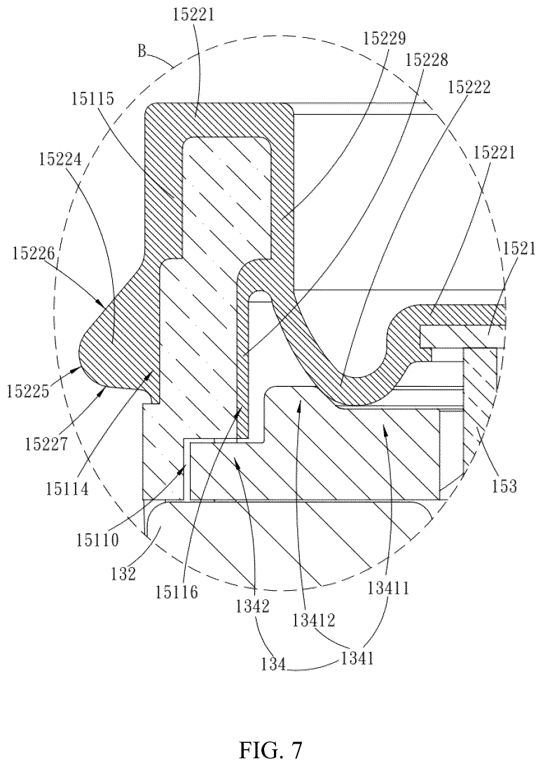

Please refer to FIG. 6 and FIG. 7 together, FIG. 6 is an enlarged view of region B in FIG. 5, and FIG. 7 is an enlarged operation diagram of region B in FIG. 5. In this embodiment, the auxiliary magnetic guide component 134 has a first bearing platform 1341 and a second bearing platform 1342, a height from the top surface of the first bearing platform 1341 to the top surface of the auxiliary magnetic 132 is higher than a height from the top surface of the second bearing platform 1342 to the top surface of the auxiliary magnetic 132. In other words, the vertical height from the top surface of the first bearing platform 1341 to the bottom surface of the elastic support component 1522 is higher that the vertical height from the top surface of the second bearing platform 1342 to the bottom surface of the elastic support component 1522. The abovementioned illustrates the distance from the top surface of the second bearing platform 1342 to the bottom surface of the elastic support component 1522 is shorter. If the elastic part 15222 of the elastic support component 1522 is compressed under external pressure (such as being submerged underwater, etc.), the bottom surface of the elastic part 15222 will concave inward, and the top surface of the second bearing platform 1342 can assist in supporting the bottom surface of the elastic part 15222. This helps the elastic part 15222 resist external pressure, reducing the risk of the elastic part 15222 being affected or fractured due to external force pressure.

Furthermore, the first bearing platform 1341 further includes a first protrusion platform 13411 and a second protrusion platform 13412, a height from the top surface of the second protrusion platform 13412 to the top surface of the auxiliary magnetic 132 is higher than a height from the top surface of the first protrusion platform 13411 to the top surface of the auxiliary magnetic 132. In other words, a vertical height from the top surface of the first protrusion platform 13411 to the bottom surface of the elastic support component 1522 is higher than a vertical height from the top surface of the second protrusion platform 13412 to the bottom surface of the elastic support component 1522. The top surface of the first protrusion platform 13411 is inclined and connected to the top surface of the second protrusion platform 13412. The abovementioned illustrates the distance from the top surface of the second protrusion platform 13412 to the bottom surface of the elastic support component 1522 is shorter. If the elastic part 15222 of the elastic support component 1522 is similarly subjected to pressure causing inward concavity, the top surface of the second protrusion platform 13412 will first support the bottom surface of the clastic part 15222, subsequently, the side surface will support the bottom surface of the elastic part 15222, and finally, the top surface of the first protrusion platform 13411 will support the bottom surface of the elastic part 15222. The abovementioned method gradually transfers the pressure from the bottom surface of the elastic part 15222 to the first bearing platform 1341 and guides the pressure of the bottom surface of the elastic part 15222 in an inward direction, making the stress concentrate towards the diaphragm 1521. In this embodiment, the vertical height H1 from the top surface of the second protrusion platform 13412 to the top surface of the first protrusion platform 13411 is larger than or equal to half of the vertical height H2 from the bottom surface of the elastic part 15222 to the bottom surface of the diaphragm 1521. Thus, by limiting the amplitude of the diaphragm 1521 relative to the elastic part 15222, the height difference between the top surface of the first protrusion platform 13411 and the top surface of the second protrusion platform 13412 is restricted.

Please refer to FIG. 3 and FIG. 4 together, the speaker device 1 further includes a conductive component 17, the conductive component 17 includes a conductive part 171 and a conductive circuit 172. The conductive part 171 is fixed on the bottom of the magnetic guide plate 11, one end of the conductive part 171 extends and is fixed on the auxiliary magnetic guide component 134, one end of the conductive circuit 172 is connected to one end of the conductive part 171, the other end of the conductive circuit 172 is connected to the voice coil 153. In this embodiment, by the conductive part 171 positioned on the bottom of the magnetic guide plate 11 being electrically connected to the external power (not shown), the conductive part 171 transmits power to the voice coil 153 via the conductive circuit 172.

Furthermore, the inner side of the auxiliary magnetic guide component 134 has a circuit notch 1343, and one end of the conductive circuit 172 passes through the circuit notch 1343 to connect to the voice coil 153. This is beneficial for the conductive circuit 172 passing through the auxiliary magnetic guide component 134 to connect to the voice coil 153 to avoid the condition that the voice coil 153 vibrates and interacts with the conductive circuit 172 to make the conductive circuit 172 produce vibration. The circuit notch 1343 can reduce the vibration of the conductive circuit 172 subjects to the interference of the auxiliary magnetic guide component 134, and thus avoid the conductive circuit 172 in turn affects the vibration of the voice coil 153. In this embodiment, when the voice coil 153 receives power to change the magnetic field, the voice coil 153 interacts with the magnetic circuit 13 to make the voice coil 153 produce vibration, driving the diaphragm 1521 and the elastic support component 1522 of the vibration component 152 vibrate, and thus the diaphragm 1521 produces sound via vibration.

In summary, the present application provides a speaker device, by positioning the first protrusion platform 13411 and second protrusion platform 13412 of the first bearing platform 1341 under the elastic support component 1522, the distance from the first bearing platform 1341 to the elastic support component 1522 is less than half the amplitude of the vibration component 152 of the speaker device 1. When the elastic support component 1522 undergoes inward concave deformation due to external pressure, the first protrusion platform 13411 and the second protrusion platform 13412 of the first bearing platform 1341 support the bottom of the elastic support component 1522 so that the first bearing platform 1341 can enhance the outward supporting strength of the elastic support component.

It is to be understood that the term “comprises”, “comprising”, or any other variants thereof, is intended to encompass a non-exclusive inclusion, such that a process, method, article, or device of a series of elements not only include those elements but also comprises other elements that are not explicitly listed, or elements that are inherent to such a process, method, article, or device. An element defined by the phrase “comprising a . . . ” does not exclude the presence of the same element in the process, method, article, or device that comprises the element.

Although the present invention has been explained in relation to its preferred embodiment, it does not intend to limit the present invention. It will be apparent to those skilled in the art having regard to this present invention that other modifications of the exemplary embodiments beyond those embodiments specifically described here may be made without departing from the spirit of the invention. Accordingly, such modifications are considered within the scope of the invention as limited solely by the appended claims.

What is claimed is:

1. A speaker device, comprising:
a magnetic guide plate;
a magnetic circuit module comprising a main magnetic, an auxiliary magnetic, a main magnetic guide component and an auxiliary magnetic guide component, wherein the main magnetic and the auxiliary magnetic are disposed on the magnetic guide plate, the auxiliary magnetic is disposed outside of the main magnetic, the main magnetic guide component is disposed on the main magnetic, the auxiliary magnetic guide component is disposed on the auxiliary magnetic, the auxiliary magnetic guide component further comprises a first bearing platform and a second bearing platform, the first bearing platform is disposed inside of the second bearing platform, the first bearing platform further comprises a first protrusion platform and a second protrusion platform, the first protrusion platform is located inside of the second protrusion platform, and a height from a top surface of the second protrusion platform to a top surface of the auxiliary magnet is higher than a height from a top surface of the first protrusion platform to the top surface of the auxiliary magnet;
a vibration module comprising a bracket, a vibration component and a voice coil, wherein the bracket is disposed on the auxiliary magnetic and the magnetic guide plate, the vibration component is disposed on the bracket, the vibration component comprises a diaphragm and an elastic support component, an inner side of the elastic support component supports a periphery of the diaphragm, an outer side of the clastic support component is disposed on the bracket, the elastic support component is integrally injection-molded between the diaphragm and the bracket, the elastic support component is located on the first bearing platform, the voice coil is disposed under the diaphragm, and the voice coil is located between the main magnetic and the auxiliary magnetic.

2. The speaker device as claimed in claim 1, wherein a height from a top surface of the first bearing platform to the top surface of the auxiliary magnet is higher than a height from a top surface of the second bearing platform to the top surface of the auxiliary magnetic.

3. The speaker device as claimed in claim 1, wherein a top surface of the first protrusion platform is inclined in connection to a top surface of the second protrusion platform.

4. The speaker device as claimed in claim 1, wherein the bracket comprises a frame body and a connection pillar, the frame body is disposed on the auxiliary magnetic, one end of the connection pillar extends downward from the frame body to the magnetic guide plate to be fixed thereon.

5. The speaker device as claimed in claim 4, wherein the frame body adjacent to the auxiliary magnetic guide component has a bottom with a notch, the first bearing platform of the auxiliary magnetic guide component embeds in the notch.

6. The speaker device as claimed in claim 4, wherein the auxiliary magnetic guide component has an outer side with a side notch, and the connection pillar has one end passing through the side notch.

7. The speaker device as claimed in claim 4, wherein the auxiliary magnetic has two sides, each with its respective notch, and the connection pillar has one end passing through the notch.

8. The speaker device as claimed in claim 4, wherein the magnetic guide plate has an outer side with a plate notch and has a bottom surface, the connection pillar has one end passing through the plate notch, and the one end of the connection pillar is fixed on the bottom surface of the magnetic guide plate.

9. The speaker device as claimed in claim 4, wherein the frame body of the bracket comprises a top wall, an inner sidewall and an outer sidewall, two sides of the top wall connect to the inner sidewall and the outer sidewall respectively, the elastic support component comprises a connection part, an elastic part with an inner side and an outer side, and a fixing part with an inner side, the connection part has an inner side surrounding a periphery of the diaphragm, the connection part has an outer side connecting to an inner side of the elastic part, an outer side of the elastic part is connected to an inner side of the fixing part, and the fixing part is formed on the inner sidewall, the top wall and the outer sidewall.

10. The speaker device as claimed in claim 9, wherein a vertical height from the top surface of the second protrusion platform to the top surface of the first protrusion platform is greater than or equal to half of a vertical height from a bottom end of the elastic part to a bottom of the diaphragm.

11. The speaker device as claimed in claim 9, wherein one side of the fixing part corresponding to the outer sidewall comprises a protrusion part.

12. The speaker device as claimed in claim 11, wherein the protrusion part comprises a convex surface, a first side surface and a second side surface, the first side surface and the second side surface are located two sides of the convex surface respectively, and the first side surface and the second side surface are symmetrically disposed relative to the convex surface.

13. The speaker device as claimed in claim 9, wherein the outer sidewall comprises a first recess, and the fixing part covers the first recess.

14. The speaker device as claimed in claim 13, wherein the outer sidewall further comprises a second recess, the second recess is located in the first recess, and the second recess is adjacent to the top wall.

15. The speaker device as claimed in claim 14, wherein the first recess and the second recess are disposed in a stepped configuration.

16. The speaker device as claimed in claim 9, wherein the inner sidewall comprises a third recess with a recess bottom, a recess wall and a sidewall, the outer side of the elastic part comprises a first elastic connection part and a second elastic connection part, the first elastic connection part extends and attaches toward the recess bottom and recess wall of the third recess, the second elastic connection part extends and attaches toward above of the sidewall of the third recess, and the second elastic connection part is connected to the fixing part.

17. The speaker device as claimed in claim 16, wherein the inner side of the connection part surrounds a top surface of the diaphragm, a thickness of the connection part at a center of the diaphragm is thinner than a thickness of the connection part at the periphery of the diaphragm.

18. The speaker device as claimed in claim 17, wherein the connection part extends and surrounds a bottom periphery of the diaphragm.
